(19) United States
(12) Patent Application Publication
(10) Pub. No.: US 2007/0140406 A1
(43) Pub. Date: Jun. 21, 2007

(54) Device for moving a control bar of a pressurized water nuclear reactor and method for mounting said device on a vessel cover

(76) Inventor: Louis Mazuy, Courbevoie (FR)

Correspondence Address: KENYON & KENYON LLP, ONE BROADWAY, NEW YORK, NY, 10004, US

(21) Appl. No.: 10/588,941

(22) PCT Filed: Feb. 3, 2005
(86) PCT No.: PCT/FR05/00236

§ 371 Date: Aug. 7, 2006

(30) Foreign Application Priority Data
Feb. 10, 2004 (FR) 0401292

(51) Int. Cl. G21C 7/00

(52) U.S. Cl. 376/327

(57) ABSTRACT

The adapter (12) and the mechanism housing (13) are made in a single piece, in the form of an integrated housing that is attached by means of the adapter tube (12) in a penetration opening (9a, 9b) of the vessel head (10). The tubular sheath (14) comprises a threaded part (14a) that is screwed into a tapped part (13c) at the end of the integrated housing (15), in a perfectly coaxial disposition. A sealing weld (18) is made between two respective sealing lips of the integrated housing (15) and of the tubular sheath (14). The weld joint (18) is made by melting a filler metal between two joining end parts of the sealing lips by an automatic orbital welding method. The step for mounting and welding the tubular sheath (14) onto the integrated housing (15) may be carried out on the nuclear reactor site with a faultless production of the welded joint (18).

### FIELD OF THE INVENTION

The invention relates to a device for moving a control bar of a pressurized water nuclear reactor and a method for mounting the device on a vessel head.

### BACKGROUND INFORMATION

Pressurized water nuclear reactors usually comprise a generally cylinder-shaped vessel placed with its vertical axis enclosing the nuclear reactor core consisting of straight prism-shaped assemblies juxtaposed and placed with their axis parallel to the axis of the vessel. The vessel comprises a top end that is closed by a generally hemisphere-shaped removable head that is attached to the vessel in a manner that seals the high pressure and high temperature nuclear reactor cooling water which fills the vessel when the nuclear reactor is operating.

In order to regulate the reactivity of the core when the nuclear reactor is operating, inside certain of the core assemblies, control bars consisting of clusters of rods made of neutron-absorbent material are moved in the axial vertical direction of the assemblies. The movement of each of the control bars inside the nuclear reactor core, to regulate the reactivity of the core, is performed by a moving device making it possible to obtain movements and a precise position of the control bar in the height of the core.

Each of the control bar moving devices comprises a control rod of great length (greater than the height of the core that is itself usually more than 4 m) which comprises, at one of its longitudinal axial ends, removable means of attachment to the top part of a control bar and, depending on its length, on its external lateral surface, grooves regularly spaced in the axial direction of the control rod defining a set of teeth for the engagement of latch arms for holding and moving mechanisms of the moving device.

The moving device comprises a containment closed and connected to the vessel in a sealed manner providing the support and the housing of the moving mechanisms and in which the extremely long control rod connected to a control bar may move between a position for extracting the control bar from the core and a position for completely inserting the control bar into the core. The containment of the moving device comprises an adapter tube attached inside an opening penetrating the head of the vessel in an axial direction of the vessel, a tubular housing supporting and containing the electromagnetic mechanisms for moving the control bar attached in the axial extension of the adapter tube to the outside of the vessel and a sheath making it possible to receive the top part of the control rod during its movements attached in the axial extension of the mechanism housing toward the outside of the vessel. The containment is attached in the vessel head in a sealed manner by crimping and welding and the connections between the adapter tube and the housing, on one hand, and between the housing and the sheath, on the other hand, are made in a manner that is perfectly sealed and resistant to the pressurized cooling water of the nuclear reactor. The sheath attached to the end of the housing opposite to its end connected to the adapter tube comprises a first end closed off in a sealed manner by a plug and a second, open, end, at which the sheath is connected in a coaxial and end-to-end manner to the mechanism housing. The containment in which the control rod moves in the axial direction therefore forms a totally sealed containment extending the vessel in the axial direction, above the head.

According to a conventional embodiment, the sealed containment of a control bar moving device comprises an adapter made of 690 nickel alloy that is factory-fitted, during the construction of the nuclear reactor, to the vessel head, inside an opening penetrating the head, by a filler-metal welding method that is perfectly controlled as to the metallurgical quality of the weld. The adapter comprises, at its free end outside the vessel head, a flare shape that is threaded on its outer surface and the mechanism housing comprises, at its end designed to be assembled to the adapter, a tapped bore matching the threaded part of the adapter, so that the mechanism housing is screwed onto the end part of the adapter, in a disposition perfectly coaxial with the adapter. The seal between the adapter and the mechanism housing is provided by lips in the shape of portions of a torus or a cylinder fixedly attached to the external surface of the adapter and of the mechanism housing in their part coming to engage with one another, the sealing lips each comprising a free annular end surface in a plane perpendicular to the axis of the adapter or of the mechanism housing.

The two free end surfaces of the sealing lips come to face one another, after the mechanism housing is screwed onto the end part of the adapter. The connection is sealed by welding the two sealing lips at their free annular facing surfaces by producing an annular weld joint in a direction perpendicular to the axis common to the adapter and the mechanism housing.

The tubular sheath whose first end is closed off usually by a plug engaged in and welded to the sheath comprises, at a second axial open end for engagement and attachment to the housing, an end part that is threaded on its external surface designed to be assembled by screwing with a tapped bore part at the corresponding end of the housing opposite to its end connected to the adapter tube. After the end of the tubular sheath has been screwed into the corresponding end of the mechanism housing, the seal between these two elements is achieved by welding facing surfaces of a sealing lip fixedly attached to the external surface of the mechanism housing and a sealing lip fixedly attached to the external surface of the tubular sheath. The sealing lips have a wall in the form of a portion of a torus and the joining surfaces of the two sealing lips coming facing one another after the tubular sheath is screwed into the mechanism housing are cylindrical surfaces having as their axis the axis common to the tubular sheath and the housing. The two sealing lips may be welded together with an electrode having a direction parallel to the axis of the two pieces to be joined, via the top of the sealing lips to form a welded sealing joint having an Ω-shaped cross section. Accordingly, this joint is usually called an OMEGA joint.

The mounting of control bar moving devices on nuclear reactor vessel heads is usually carried out entirely at the factory, the tubular sheath being closed off by a welded plug attached at its first end and then screwed via its second end into the corresponding end of the mechanism housing (the mechanisms having been previously mounted on and in the housing). The sealing lips are welded together to form the OMEGA joint and the housing is screwed via its end opposite to the tubular sheath onto the top part of an adapter. The seal is then made between the adapter and the mechanism housing by a weld on the sealing lips facing one another. This weld must be made with an electrode perpendicular to the axis of the adapter and the mechanism housing, that is to say in a horizontal position, the vessel head being in a position similar to its head closed position. Producing this welded joint is therefore substantially more awkward than producing the OMEGA joint. In addition, during the operation of the nuclear reactor, the nuclear reactor's pressurized water penetrates into the sealed containment of the mechanism moving device and comes into contact with the internal surface of the welded joints of the sealing lips. Placing pressurized and high-temperature water in contact with the internal part of the welded joints may cause a certain corrosion, in particular on the bottom joint between the adapter and the mechanism housing which is closer to the inside of the vessel and therefore at a higher temperature.

Because of the difficulty of producing the joint between the adapter and the mechanism housing and the risk of corrosion of the sealing weld, it has been proposed to produce the adapter tube and the mechanism housing in a single piece. In this case, the housing fixedly attached to the adapter tube, usually called the integrated housing, is attached to the vessel head at the factory, when the adapter tube is mounted and attached to the vessel head.

The mounting of the tubular sheath onto the mechanism housing that is performed as previously described may be carried out at the factory with a careful implementation and an inspection of the OMEGA joint. As described in Japanese patent application JP-10-319164, to prevent the use of an OMEGA-type sealing joint between the tubular sheath and the mechanism housing, it has been proposed to join the tubular sheath and the mechanism housing by butt welding.

Specifically, it has seemed, in the context of manufacturing vessel heads at the factory, that the production of OMEGA joints of perfect quality capable of withstanding corrosion by the nuclear reactor's pressurized water mixed with air required more complex operations of machining and welding than a butt-welding assembly of the tubular sheath and the mechanism housing.

Such a method with butt welding of the sheaths onto the housings makes it necessary to achieve the mounting at the factory of the complete vessel heads which, after their manufacture, are extremely high. The operations of transport to the site and of putting a complete head into a reactor building, both during the construction of a new reactor and for the replacement of a vessel head, are complex.

In addition, if it is desired to carry out an on-site repair of a control bar moving device, it may be necessary to remove the tubular sheath from the moving device and to reinstall, after repairing the mechanisms, a tubular sheath in a perfect disposition relative to the mechanism housing, which requires extremely complex operations to achieve a good axial alignment of the tubular sheath and the housing and an end-to-end assembly in two horizontal sections perfectly facing one another. In addition, the welding has to be performed out with a welding electrode in a substantially horizontal position.

For operations to replace or repair control bar moving mechanisms on site in particular, it would be preferable to use a method of assembly by screwing the sheaths onto the housings and welding sealing lips which automatically ensures a very good axial alignment and a very good seal, if it were possible to carry out a perfect quality welding of the sealing lips of the sheath and the housing and an effective inspection of the weld seam. The known devices cannot be mounted easily and with a very good quality of production of the sealing weld, particularly on site. In addition, it is not possible to inspect the internal (or port side) parts of the welds.

### SUMMARY

The objective of the invention is therefore to propose a device for moving a bar for controlling the reactivity in the core of a pressurized water nuclear reactor, inside a vessel enclosing the reactor core closed off by a vessel head, comprising a control rod furnished with an arrangement of attaching the control bar at one axial end, an electromechanical arrangement for moving the control rod in an axial direction and a sealed containment attached to the vessel head in a penetration opening comprising an adapter tube welded to the opening of the head and a tubular mechanism housing fixedly attached to the adapter on which are mounted the electromechanical arrangement for moving the control rod and a tubular sheath allowing the control rod to be axially moved between two extreme positions, closed at a first end and open at a second end, attached in the axial outward extension of the housing, by its second, open, end, characterized in that the adapter and the mechanism housing are made in a single piece, that the mechanism housing comprises, at an axial end opposite to the adapter, an internal tapping and a sealing lip in the shape of a portion of a torus surrounding the housing and made in its external surface, having a cylindrical free joining surface having as its axis the axis of the housing, and that the tubular sheath comprises, at its second, open, end, a thread matching the tapping of the housing on its external surface for it to be attached by screwing in a coaxial disposition into the housing and a sealing lip in the shape of a portion of a torus surrounding the external surface of the sheath and matching the sealing lip of the mechanism housing, having a cylindrical free joining end having as its axis the axis of the sheath, the sealing lips of the housing and of the sheath having their free ends facing one another after the sheath has been screwed into the housing and being welded to one another along an annular weld seam made of filler metal coaxial with the housing and with the sheath having a depth in a direction parallel to the axis and a width in a direction perpendicular to the axis that are substantially constant over the whole circumference of the weld seam.

According to more particular features taken in isolation or in combination:
the tubular-shaped adapter and the mechanism housing are butt welded in a coaxial disposition to form an integrated housing attached to the vessel head by an arrangement of the adapter tube,
the adapter tube is made of nickel alloy and the mechanism housing of stainless steel,
the tubular sheath is made of stainless steel, and the sealing lips of the integrated housing and of the tubular sheath made in a single piece, respectively with the housing and the tubular sheath, are made of stainless steel.

The invention also relates to a method of mounting a device for moving a bar for controlling the reactivity in the core of a pressurized water nuclear reactor inside a vessel enclosing the reactor core closed off by a vessel head, comprising a control rod furnished with an arrangement of attaching the control bar at one axial end, an electromechanical arrangement for moving the control rod in an axial direction and a sealed containment attached to the vessel head in a penetration opening comprising an adapter tube welded into the opening of the vessel head and a tubular mechanism housing fixedly attached to the adapter on which are mounted the electromechanical arrangement for moving the control rod and a tubular sheath allowing the control rod to be axially moved between two extreme positions, closed at a first end and open at a second end, the housing being fixedly attached to the adapter and placed in its axial extension toward the outside of the vessel and the tubular sheath being attached in the axial outward extension of the housing, by its second, open, end, characterized in that the mounting and the attachment by welding in a penetration opening of the vessel head of an integrated housing comprising the adapter and the mechanism housing are performed out in a single piece, that the tubular sheath is screwed by its second threaded end part into the tapped part of the end of the integrated housing, so as to place cylindrical end connection surfaces facing one another having as their axis a common axis of the integrated housing and of the tubular sheath in the assembled position, of a first sealing lip fixedly attached to the integrated housing and of a second sealing lip fixedly attached to the tubular sheath, and that a sealed join of the sealing lips is achieved by an annular weld joint by automatic orbital welding, with the melting of an annular piece made of filler metal interposed between the end connection surfaces of the sealing lips.

According to more particular modalities taken in isolation or in combination:
prior to producing the weld joint, the automatic welding parameters are determined by calibration operations on samples,
the weld joint is made by an automatic orbital TIG process, that is to say with melting of the piece made of annular filler metal by a tungsten electrode under inert gas.

### BRIEF DESCRIPTION OF DRAWINGS

In order to ensure that the invention is properly understood, a description will now be given as an example, with reference to the attached figures, of a device for moving control bars of a pressurized water nuclear reactor, a sealed containment of the device made according to the invention and a method of mounting and attaching the moving device that can be achieved at the factory or on site.

FIG. 1 is an exploded view in perspective of a control bar moving device according to the prior art.

FIG. 2 is a partial view in section of a vessel head and sealed containments of control bar moving devices according to the invention.

FIG. 3 is an enlarged view of the detail 3 of FIG. 2.

FIG. 4 is a view in axial section of an integrated mechanism housing of a moving device according to the invention.

FIG. 5 is an enlarged view in section of the sealing lips of the mechanism housing and of the tubular sheath of a moving device according to the invention during an operation of producing the sealing weld.

### DETAILED DESCRIPTION OF DRAWINGS

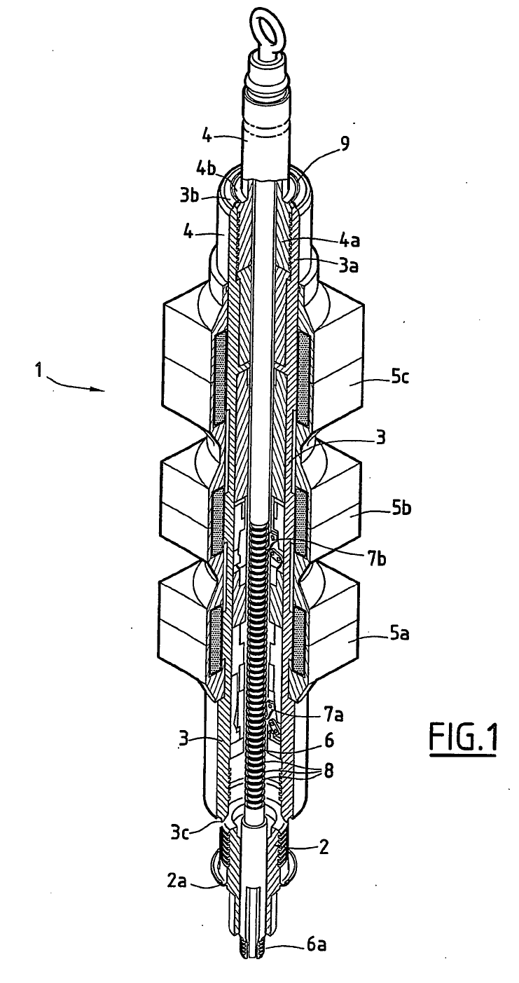

FIG. 1 shows a device for moving control bars of a pressurized water nuclear reactor indicated generally by reference number 1.

The moving device 1 shown in FIG. 1 is produced according to the prior art described hereinabove and has been shown in a mounting position on an adapter tube 2 attached in a penetration opening of a vessel head of a pressurized water nuclear reactor. The adapter 2 forms the bottom part of the sealed containment of the moving device 1 which also comprises a housing 3 and a tubular sheath 4.

The adapter 2, the housing 3 and the sheath 4 made in tubular shape are assembled in coaxial dispositions and in the axial extension of one another.

The mechanism housing 3 supports three magnetic coils 5a, 5b and 5c for controlling mechanisms contained in the mechanism housing 3 making it possible to move a control rod 6 in the axial direction common to the adapter and the housing and the tubular sheath. The control rod 6 comprises, at its bottom axial end, an arrangement 6a for attaching a control bar of the nuclear reactor. The lateral surface of the control rod 6 comprises grooves defining a set of teeth 8 for the step by step movement of the control rod actuated by the mechanisms contained in the housing 3. The mechanisms comprise in particular a holding latch arm 7a and a transfer latch arm 7b controlled, respectively, to open to release the latch arms of the set of teeth 8 of the control rod, by the coils 5a and 5b placed around the housing 3.

The coil 5c is a coil for raising the control rod (and the control bar attached at the end of the control rod), when the transfer latch arms 7b are engaged in the set of teeth 8 of the control rod.

The closing of the latch arms, when the corresponding coils are not controlled to open, and the descent of the control bar are achieved by return springs pressing on the movable parts inside the housing 3.

In the case of a control bar moving device according to the prior art as shown in FIG. 1, first the mechanisms are mounted inside the mechanism housing 3 and the coils 5a, 5b and 5c are mounted then the tubular sheath 4 and the mechanism housing 3 are assembled. To do this, a bottom threaded part 4a of the tubular sheath 4 is screwed into a matching tapped part 3a of the mechanism housing 3 and then a torus-shaped sealing lip 3b of the mechanism housing 3 and a matching sealing lip 4b that is also torus-shaped of the tubular sheath 4 are welded along a weld joint 9. The annular weld joint 9 has as its axis the axis common to the tubular sheath 4 and the mechanism housing 3.

The weld 9 may be made in a preparatory workshop comprising an arrangement suitable for producing a quality weld.

The assembly comprising the tubular sheath and the mechanism housing supporting and enclosing the electromechanical control mechanisms is then screwed onto the threaded terminal part of the adapter 2, the seal being provided by welding facing surfaces of two sealing lips 2a and 3c made respectively on the external surface of the adapter and on the housing 3.

The disadvantage of the mounting method according to the prior art is that the production of the weld between the sealing lips 2a and 3c is awkward, due to the position of the surfaces to be welded, the thinness of the sealing lips and the production of the adapter and the mechanism housing 3 in two different materials (nickel alloy for the adapter and, usually, 304 stainless steel for the mechanism housing 3).

In addition, in the case of an on-site repair of the mechanisms of a control bar, it has not been possible hitherto to produce the sealing weld 9 of the lip 3b of the mechanism housing 3 and the sealing lip 4b of the tubular sheath 4 in perfect conditions and guaranteeing that no defects are present. In particular, it is difficult to guarantee a good penetration and a constant thickness of the weld throughout the whole thickness of the sealing lips and along the whole periphery of the welded joint 9.

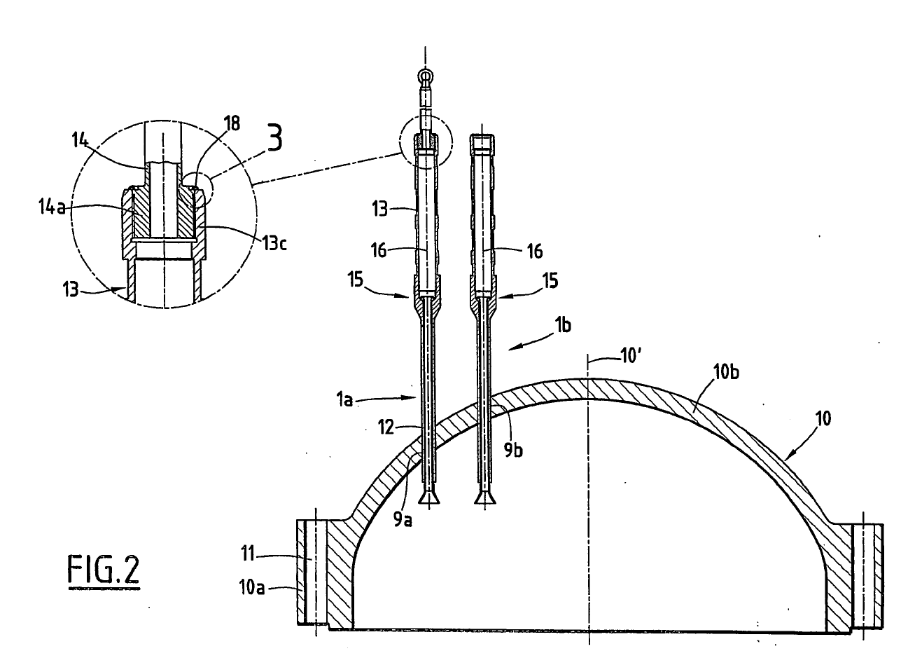

In order to remedy these defects, in particular in the case of an on-site repair of a vessel head or a replacement of a vessel head, the sealed casings of the devices for moving control bars are made as shown in FIG. 2.

FIG. 2 shows the vessel head 10 of a pressurized water nuclear reactor to which are attached sealed casings of devices for moving control bars.

The head 10 comprises a flange 10a of great thickness that is traversed by openings 11 for the passage of studs for attaching the head 10 to a top end flange of a nuclear reactor vessel. The head 10 comprises a central curved part 10b in the form of a spherical cap that is traversed by openings such as 9a and 9b in the direction of the axis 10′ of the vessel head that is designed to be attached in a centered position on the top end of the vessel, so that the axis 10′ of the head is placed along the vertical axis of the vessel in the service position.

The vessel head is traversed by many openings in each of which is attached a sealed containment of a control bar moving device having the general shape and the functions described hereinabove.

FIG. 2 shows a sealed containment of a first control bar moving device 1a in the fully assembled state and a part of a containment of a second control bar moving device 1b without its top part consisting of a tubular sheath for moving a control rod. The top part of the device 1a has also been shown in enlarged form on the left of the figure.

According to the invention, the adapter tube 12 attached in the vessel head and the mechanism housing 13 of the moving device are made as a single piece and attached to the vessel in their entirety, the adapter tube 12 and the mechanism housing 13 forming an integrated housing which will be indicated in a general manner by reference number 15.

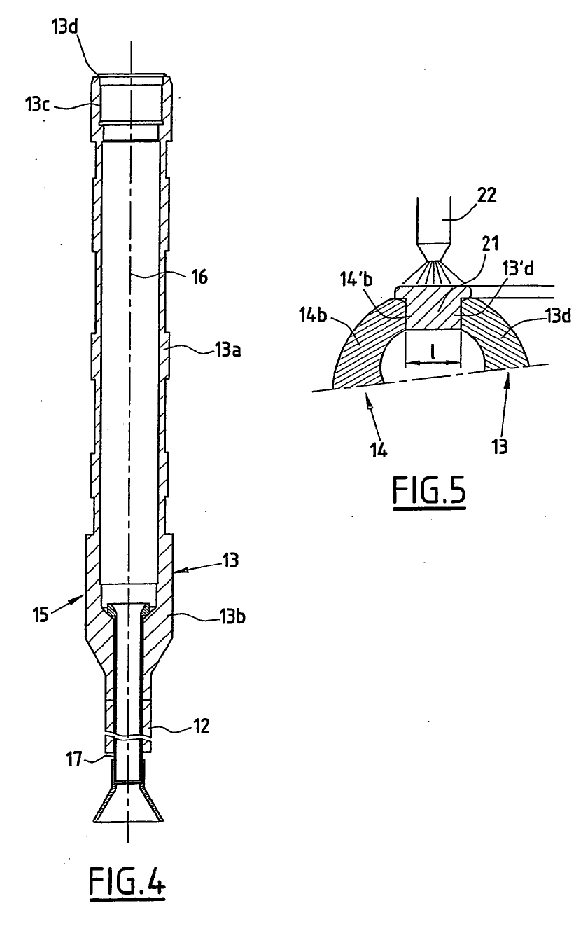

Shown in FIG. 4, on a larger scale, is an integrated housing 15 of the sealed containment of a control bar moving device according to the invention.

The integrated housing 15 comprises a bottom part 12 consisting of an adapter tube of constant diameter that may advantageously be made of a nickel alloy such as the corrosion-resistant alloy 690. The top part of the integrated housing 13 comprises, on one hand, the mechanism housing 13a itself and a bottom part 13b for connection to the adapter 12.

The tubular adapter 12 is assembled end-to-end in a coaxial disposition (along the axis 16 of the integrated housing) with a section of the bottom end part 13b of the housing 13 having a diameter that is substantially equal to the diameter of the adapter tube.

The end-to-end assembly of the adapter tube 12 and the housing 13 is carried out at the factory by a joining method making it possible to produce a high quality metallurgical assembly between the adapter tube made of nickel alloy and the mechanism housing 13 that is usually made of 304 stainless steel. This therefore gives a single piece comprising the adapter tube 12 and the mechanism housing 13 assembled end-to-end forming the integrated housing 15.

The adapter tube 12 is engaged and welded into a penetration opening of the vessel head so that the axis 16 of the integrated housing is parallel to the axis 10′ of the vessel head.

To complete the assembly of the control bar moving device, a thermal sleeve 17 followed by the mechanisms inside the bore of the top part 13a of the integrated housing 15 are installed inside the integrated housing 15, in its bottom part. The top part 13a of the integrated housing is machined so as to receive the coils of the mechanisms on its external surface.

On its top part, the integrated housing comprises a tapped part 13c that is designed to receive a bottom threaded part of the tubular sheath 14 that is screwed in a coaxial disposition into the integrated housing, as shown in FIG. 2.

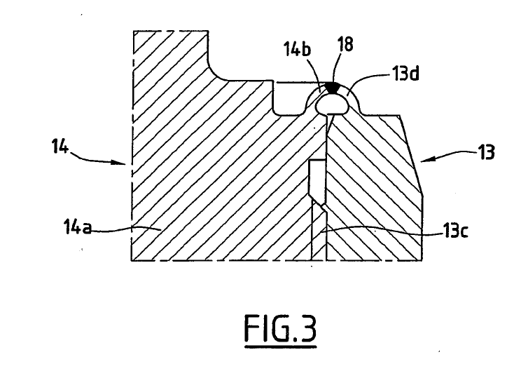

As can be seen in FIG. 3, after the threaded bottom part of the tubular sheath 14 has been screwed into the top end part 13c of the tubular sheath, a sealing lip in the shape of a portion of a torus 14b made on the external surface of the tubular sheath, above its threaded part 14a for engagement by screwing into the integrated housing comes face to face with a lip in the shape of a portion of a torus 13d provided on the top part of the integrated housing, above the tapped part 13c.

A sealed join between the tubular sheath 14 and the housing 13 is provided by an annular weld seam 18 joining the two facing edges of the lips in the shape of portions of a torus 14b and 13d.

The top end of the tubular sheath 14 is closed off by a plug 19 comprising a lifting ring that is screwed into a tapped end part of the sheath 14.

After the tubular sheath 14 has been screwed into the tapped part 13c of the integrated housing 15 that is attached to a vessel head, the weld seam 18 providing the seal between the lips 13d and 14b must be produced in situ.

This operation can be performed either at the factory, during the manufacture of a head, or on site, in the case of a replacement of a vessel head of a nuclear reactor. In this case, the vessel head to which the integrated housings 15 enclosing the control bar moving mechanisms are attached, can be transported between the manufacturing factory and the site and taken into the reactor building, the tubular sheaths not being installed on the integrated housings. Because of this, the total height of the head is substantially reduced, which makes the operations of transporting and inserting the replacement head into the reactor building considerably easier.

In this case, the tubular sheaths are supplied independently of the head comprising the integrated housings and are put in place on the site by screwing them into the top ends of the integrated housings. The sealing weld seam 18 is made on site between the lip 13d of the integrated housing and the lip 14b of the tubular sheaths.

Similarly, in the case of an operation to replace or repair control bar moving mechanisms on site, the tubular sheath is removed after grinding of the weld seam joining the sealing lips, the mechanisms are replaced or repaired, then a tubular sheath is put back in place by screwing it into the integrated housing. The weld seam 18 joining the sealing lips is then made on site.

The sealing lips and the method of welding these sealing lips have been adapted so that they can be performed on site without difficulty and with totally satisfactory implementation conditions.

FIG. 5 shows, in an enlarged view, the sealing lips 13d of an integrated housing 13 and 14b of a tubular sheath 14 respectively, after the tubular sheath 14 has been screwed into the integrated housing and at the time of making the sealing weld joint 18.

The sealing lips 13d and 14b comprise cylinder-shaped free end surfaces, 13′d and 14′b respectively, that are facing one another after the tubular sheath has been screwed in and that have as their axis the axis common to the integrated housing 13 and the tubular sheath 14 in the screwed-together position.

The lips 14b and 13d have walls delimited by torus-shaped surface portions whose cross section, visible in FIG. 6, corresponds more or less to a quarter circle. In addition, the lips 14b and 13d are made so that an I-wide annular space remains between the free end facing surfaces 14′b and 13′d of the torus-shaped lips, when the integrated housing 13 and the tubular sheath 14 have been screwed together.

The weld joint 18 is made by installing, between the free facing surfaces 14′b and 13′d of the sealing lips, an annular piece 21 made of a metal that is metallurgically compatible with the metal of the lips 14b and 13d and by performing, with the aid of an electrode 22 of an automatic orbital welding machine, the melting of the piece 21 made of filler metal and the heating of the parts of the lips 14b and 13d in contact with the piece 21 to produce a good metallurgical connection.

As shown in FIG. 6, the section of the annular piece 21 made of filler metal may advantageously have an I-wide part coming to engage practically without clearance between the lips to be welded together and a widened part to ensure that the piece is held above the lips that are being welded. After the welding operation, the sealing lips 14b and 13d and the weld joint 18 form an OMEGA-type joint of perfect quality, when an automatic orbital welding machine whose welding conditions have been previously determined by calibration on samples is used.

The joint 21 is made of filler metal usually used for the welding of stainless steels and the electrode 22 is a tungsten electrode of an orbital TIG welding machine, the melting of the filler metal 21 being achieved in an inert gas atmosphere.

The welding machine comprises an arrangement for guiding the welding head comprising the electrode 22 that may be engaged around the tubular sheath and the top part of the integrated housing, thanks to a particular support arrangement.

The welding parameters that are preset comprise in particular the speed of orbital movement of the tungsten electrode 22, the welding voltage and current and the distance from the electrode tip to the top surface of the annular piece 21 of filler metal.

The adjustment of the automatic welding conditions and the use of a joint made of filler metal of a shape and dimensions perfectly defined relative to the space between the sealing lips make it possible to produce a weld joint 18 of perfect quality and perfectly constant along the whole periphery of the sealing lips.

In this way it is possible to guarantee the production of a perfect quality welded joint and therefore a perfect seal of the OMEGA-type joint.

In addition, welding with an electrode that is practically vertical above the joint to be produced makes it possible, when the welding parameters are well determined, to obtain a perfect weld joint automatically.

The invention therefore makes it possible to mount control bar moving devices onto a nuclear reactor vessel head, with the installation of tubular containments on the nuclear reactor site, with a very good achievement of the alignment of the tubular containments relative to the integrated housings attached to the vessel head and with a very good seal.

The invention is not limited to the embodiment that has been described. It is therefore possible to imagine the use of welding types other than orbital TIG welding to produce the welded joint of the sealing lips.

It is also possible to provide sealing lips having a different shape from that which has been described, from the moment when these sealing lips have joining surfaces that are facing one another after the cylinder-shaped tubular sheath has been screwed in and are coaxial having as their axis the axis common to the integrated housing and the tubular sheath.

The invention applies to any nuclear reactor comprising control bar moving devices having sealed containments attached in penetration openings of the nuclear reactor vessel head.

1-7. (canceled)

8. A device for moving a bar for controlling reactivity in a core of a pressurized water nuclear reactor inside a vessel enclosing the reactor core closed off by a vessel head, comprising:
a control rod furnished with an arrangement for attaching the control bar at one axial end;
an electromechanical arrangement for moving the control rod in an axial direction; and
a sealed containment attached to the vessel head in a penetration opening comprising:
an adapter tube welded into the opening of the vessel head;
a tubular mechanism housing connected to the adapter on which is mounted the electromechanical arrangement for moving the control rod; and
a tubular sheath configured to allow the control rod to be axially moved between two extreme positions, closed at a first end and open at a second end, attached in the axial outward extension of the housing, by the tubular sheath second, open, end, wherein the adapter and the mechanism housing are made in a single piece, and the housing comprises, at an axial end opposite to the adapter, an internal tapping and a sealing lip in a shape of a portion of a torus surrounding the housing and made in an external surface having a cylindrical free joining surface having as an axis the axis of the housing, and that the tubular sheath comprises, at the second, open, end, a thread matching the tapping of the housing for it to be attached by screwing in a coaxial position into the housing and a sealing lip in a shape of a portion of a torus of dimensions matching those of the sealing lip of the housing having a cylindrical free joining end surface having as an axis the axis of the sheath, the sealing lip of the housing and the sealing lip of the sheath having free ends facing one another after the sheath has been screwed into the housing and being welded to one another, along an annular weld seam made of filler metal coaxial with the housing and with the sheath of a depth in a direction parallel to the axis of the joint and of a width in a direction perpendicular to the axis of the joint that are substantially constant along the whole circumference of the weld joint.

9. The device according to claim 8, wherein the tubular-shaped adapter and the mechanism housing are butt welded in a coaxial disposition to form an integrated housing attached to the vessel head by the adapter tube.

10. The device according to claim 9, wherein the adapter tube is made of nickel alloy and the mechanism housing of stainless steel.

11. The device according to claim 10, wherein the tubular sheath is made of stainless steel, and the sealing lip of the integrated housing and the sealing lip of the tubular sheath made in a single piece, respectively with the housing and the tubular sheath, are made of stainless steel.

12. A method of mounting a device for moving a bar for controlling a reactivity in a core of a pressurized water nuclear reactor inside a vessel enclosing the reactor core closed off by a vessel head, comprising:
furnishing a control rod with an arrangement for attaching the control bar at one axial end, an electromechanical arrangement for moving the control rod in an axial direction and a sealed containment attached to the vessel head in a penetration opening comprising an adapter tube welded into the opening of the vessel head and a tubular mechanism housing fixedly attached to the adapter on which are mounted the electromechanical arrangement for moving the control rod and a tubular sheath allowing the control rod to be axially moved between two extreme positions, closed at a first end and open at a second end;
attaching the housing being to the adapter; and
placing the housing in an axial extension toward an outside of the vessel; and
attaching the tubular sheath in the axial outward extension of the housing, by a second, open, end, wherein the mounting and the attachment by welding in a penetration opening of the vessel head of an integrated housing comprising the adapter and the mechanism housing are carried out in a single piece, and wherein the tubular sheath is screwed by a second threaded end part into the tapped part of the end of the integrated housing, so as to place cylindrical end connection surfaces facing one another having as their axis a common axis of the integrated housing and of the tubular sheath in the assembled position, of a first sealing lip fixedly attached to the integrated housing and of a second sealing lip fixedly attached to the tubular sheath, and that a sealed join of the sealing lips is achieved by an annular weld joint by automatic orbital welding, with the melting of an annular piece made of filler metal interposed between the end connection surfaces of the sealing lips.

13. The method according to claim 12, further comprising:
determining the automatic welding parameters by calibration operations on samples prior to producing the weld joint.

14. The method as claimed in claim 12, wherein the weld joint is made by an automatic orbital TIG process, by melting annular filler metal by a tungsten electrode under inert gas.
